(19) United States
(12) Patent Application Publication
(10) Pub. No.: US 2026/0221138 A1
(43) Pub. Date: Jul. 30, 2026

(54) INTERACTION METHOD, INTERACTION APPARATUS, ELECTRONIC DEVICE, AND COMPUTER-READABLE STORAGE MEDIUM

(71) Applicant: Beijing Zitiao Network Technology Co., Ltd., Beijing (CN)

(72) Inventors: Qi SHI, Beijing (CN); Peiyin LIN, Beijing (CN); Zijian ZHANG, Beijing (CN); Luxi ZHANG, Beijing (CN)

(21) Appl. No.: 19/322,176

(22) Filed: Sep. 8, 2025

(30) Foreign Application Priority Data
Jan. 24, 2025 (CN) 202510122152.7

(51) Int. Cl. G10L 15/22; G06F 16/334; G06F 40/30; G06T 11/60; G10L 15/26

(52) U.S. Cl. CPC G10L 15/22; G06F 16/334; G06F 40/30; G06T 11/60; G10L 15/26

(57) ABSTRACT

The present disclosure relates to an interaction method and a related apparatus. The interaction method includes: receiving an input from a user in an interaction interface with an agent; generating a reply text of the agent based on the input; outputting, in the interaction interface, an audio of the reply text corresponding to an emotional feature of the reply text according to the emotional feature; and displaying, in the interaction interface, a multimedia resource of the agent corresponding to the emotional feature according to the emotional feature.

### CROSS-REFERENCE TO RELATED APPLICATIONS

This application claims priority to Chinese Patent Application No. 202510122152.7, filed on Jan. 24, 2025, which is hereby incorporated by reference in its entirety.

### TECHNICAL FIELD

The present disclosure relates to the field of computer technologies, and more specifically, to an interaction method, an interaction apparatus, an electronic device, a computer-readable storage medium, and a computer program product.

### BACKGROUND

With the development of artificial intelligence (AI) technology and large language models, there have been many pieces of software that enable interaction with AI virtual characters. These AI virtual characters with distinct personalities and different backgrounds allow users to experience chats in a more immersive manner through various ways of interaction, answering users'questions or providing emotional value. In related interactive software, in addition to displaying reply text, a question answering function may also provide a reply voice. Generally speaking, text-to-speech (TTS) technology is used for voice interaction to synthesize audio, which is played in the process of replying to a user. However, traditional voice interaction based on TTS audio is often relatively monotonous and stereotyped, falling short of an ideal user experience.

### SUMMARY

According to some embodiments of the present disclosure, there is provided an interaction method, including: receiving an input from a user in an interaction interface with an agent; generating a reply text of the agent based on the input; outputting, in the interaction interface, an audio of the reply text corresponding to an emotional feature of the reply text according to the emotional feature; and displaying, in the interaction interface, a multimedia resource of the agent corresponding to the emotional feature according to the emotional feature of the reply text.

According to some other embodiments of the present disclosure, there is provided an interaction apparatus, including: an input module configured to receive an input from a user in an interaction interface with an agent; a reply module configured to generate a reply text of the agent based on the input; an audio module configured to output, in the interaction interface, an audio of the reply text corresponding to an emotional feature of the reply text according to the emotional feature; and a multimedia module configured to display, in the interaction interface, a multimedia resource of the agent corresponding to the emotional feature according to the emotional feature of the reply text.

According to some embodiments of the present disclosure, there is provided an electronic device, including: a memory; and a processor coupled to the memory, the processor configured to, based on instructions stored in the memory, carry out the method of any one of the embodiments described in the present disclosure.

According to some embodiments of the present disclosure, there is provided a computer-readable storage medium having a computer program stored thereon, which, when executed by a processor, carries out the method of any one of the embodiments described in the present disclosure.

Other features, aspects and advantages of the present disclosure will become apparent from the following detailed description of exemplary embodiments of the present disclosure with reference to the drawings.

### BRIEF DESCRIPTION OF THE DRAWINGS

Embodiments of the present disclosure are described hereinafter with reference to the drawings. It is to be understood these descriptions are merely illustrative and are not intended to limit the scope of the present disclosure. In the drawings:

FIG. 1 is a schematic diagram of an interaction interface between a user and an agent in the related art;

FIG. 2 is a flowchart of an interaction method between a user and an agent according to some embodiments of the present disclosure;

FIGS. 3A and 3B are schematic diagrams of an interaction interface between a user and an agent according to some embodiments of the present disclosure;

FIGS. 4A and 4B are schematic diagrams of an interaction interface between a user and an agent according to some other embodiments of the present disclosure;

FIGS. 5A to 5C are schematic diagrams of an interaction interface between a user and an agent according to some further embodiments of the present disclosure;

FIGS. 6A and 6B are schematic diagrams of an interaction interface between a user and an agent according to some additional embodiments of the present disclosure;

FIG. 7 is a schematic diagram of a method for generating an audio and a multimedia resource according to some embodiments of the present disclosure;

FIG. 8 is a schematic block diagram of an interaction apparatus between a user and an agent according to some embodiments of the present disclosure;

FIG. 9 is a block diagram of an electronic device according to some embodiments of the present disclosure;

FIG. 10 is a block diagram of an electronic device according to some other embodiments of the present disclosure.

It is to be noted that, for ease of description, the dimensions of various elements shown in the drawings are not necessarily drawn to scale. Throughout the drawings, the same or similar reference numerals refer to the same or similar elements. Therefore, once an element is defined in one drawing, it may not be discussed further in subsequent drawings.

### DETAILED DESCRIPTION OF EMBODIMENTS

The technical solutions in the embodiments of the present disclosure are described hereinafter clearly and completely with reference to the drawings in the embodiments of the present disclosure. It is to be understood these descriptions are merely illustrative and are not intended to limit the scope of the present disclosure.

It is to be noted that steps described in embodiments of the method of the present disclosure may be performed in a different order and/or in parallel. Furthermore, the embodiments of the method may include additional steps and/or omit the steps shown. The scope of the present disclosure is not limited in this respect. Unless otherwise specified, relative arrangements, numerical expressions, and values of elements and steps described in these embodiments are to be construed as merely exemplary and not to limit the scope of the present disclosure.

The term “include/comprise” and variants thereof used in the present disclosure are open-ended terms that mean “including/comprising at least the following elements/features but not excluding other elements/features”—that is, “include/comprise but not limited to”. The term “based on” means “at least partially based on”. It is to be noted that concepts such as “first”, “second” and the like mentioned in the present disclosure are merely intended to distinguish one from another apparatus, module, or unit and are not intended to limit the order or interrelationship of the functions performed by these apparatuses, modules or units. Unless otherwise specified, concepts such as “first” and “second” are not intended to imply that objects so described must be in a given order temporally, spatially, in terms of ranking, or in any other way.

It is to be noted that modifiers “one” and “a plurality” mentioned in the present disclosure are illustrative and not restrictive; those skilled in the art should understand that they should be construed as “one or more” unless otherwise clearly indicated in the context.

Names of messages or information exchanged between a plurality of apparatuses in the embodiments of the present disclosure are used for illustrative purposes only and are not intended to limit the scope of these messages or information.

User information (including, but not limited to, user device information, user personal information, etc.) and data (including, but not limited to, data for analysis, stored data, displayed data, etc.) involved in the present disclosure are information and data authorized by users or fully authorized by parties, and collection, use, and processing of related data need to comply with related laws, regulations, and standards of related countries and regions, and corresponding operation entry is provided for users to choose to authorize or reject.

Embodiments of the present disclosure are described in detail hereinafter with reference to the drawings, but the present disclosure is not limited to these specific embodiments. The following specific embodiments may be combined with each other, and the same or similar concepts or processes may not be described redundantly in certain embodiments. Furthermore, in one or more embodiments, a particular feature, structure, or characteristic may be combined in any suitable manner that will be clear to those of ordinary skill in the art from this disclosure.

It is to be understood that the present disclosure also does not limit how to acquire an image to be applied/processed. In some embodiments of the present disclosure, the image may be acquired from a storage apparatus, such as an internal memory or an external storage apparatus. In some other embodiments of the present disclosure, a photographing component may be activated to take a picture. It is to be noted that the acquired image may be a captured image or a frame of image in a captured video, which is not particularly limited thereto.

In the context of the present disclosure, an image may refer to any of a variety of images, such as a color image, a grayscale image, etc. It is to be noted that in the context of this specification, a type of the image is not particularly limited. Furthermore, the image may be any appropriate image, such as an original image obtained by a photographing apparatus or an image that has been subjected to specific processing on the original image, such as preliminary filtering, de-aliasing, color adjustment, contrast adjustment, normalization, and the like. It is to be noted that pre-processing operations may also include other types of pre-processing operations known in the art, which will not be described in detail herein.

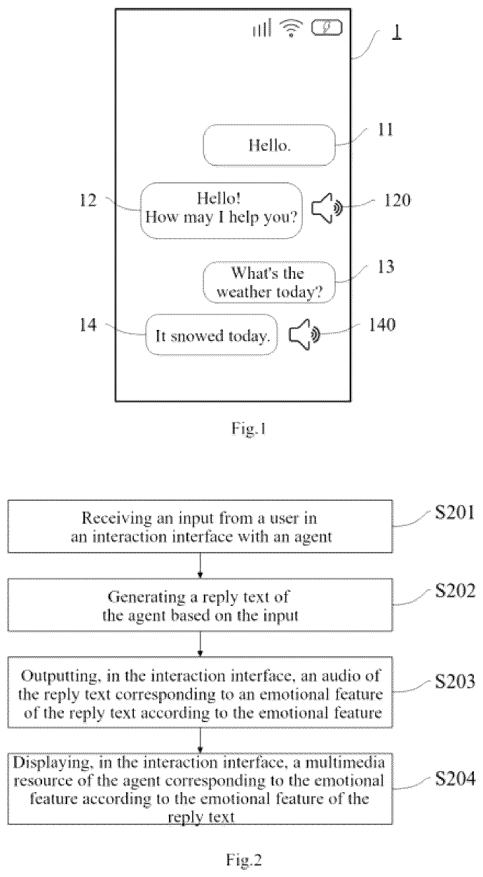

In the related art, replies of agent interaction software to user inputs usually include text display and voice output; these pieces of interactive software generate replies based on large language models (LLMs), and use TTS technology to convert reply content into conventional voice output. Specifically, reference may be made to FIG. 1, which is a schematic diagram of an interaction interface between a user and an agent in the related art. In the interaction interface 1 between the user and the agent, the user makes inputs (such as 11, 13) to the agent, and the agent generates reply texts (such as 12, 14) in response to the user's inputs; while displaying the reply texts in the interaction interface 1, text content is outputted in voice, for example, the reply text 12 corresponds to an audio 120, and the reply text 14 corresponds to an audio 140, where the audio 140 may be synthesized using the TTS technology. It is to be understood that icons of the audios 120, 140 are merely used to describe various output forms of the agent's replies, rather than to limit the visual presentation effect of the interaction interface 1.

Similar to the interaction interface shown in FIG. 1, the synthesized audio in the related art may only monotonously convey literal content of the reply text, but lacks emotional value in terms of creating a sense of situation and experience for the user. To address this issue, the present disclosure provides an interaction method in which an audio and images corresponding to a reply text may be outputted in a manner rich in emotion in an interaction interface between a user and an agent, thereby enhancing the user's multi-faceted perception including vision and hearing and providing the user with an immersive experience.

Specifically, FIG. 2 is a flowchart of an interaction method between a user and an agent according to some embodiments of the present disclosure.

As shown in FIG. 2, in step S201, an input from the user in the interaction interface with the agent is received; in step S202, a reply text of the agent is generated based on the input; in step S203, an audio of the reply text corresponding to an emotional feature of the reply text is outputted in the interaction interface according to the emotional feature; and in step S204, a multimedia resource of the agent corresponding to the emotional feature is displayed in the interaction interface according to the emotional feature of the reply text.

The interaction method of this embodiment may be executed on a client or partially executed on a server.

Generally speaking, the emotional feature in the present disclosure is used to describe emotion corresponding to text content, such as emotion labels representing user's moods and feelings, such as happiness, sadness, anger, surprise, etc., or scene settings providing different experiences for the user, such as weather, location, activity, etc., so as to summarize and refer to corresponding features of the text.

The audio of the reply text is outputted to the user by a sound-producing apparatus such as a microphone, and includes, for example, a character voice of a virtual character of the agent in the current interaction interface, a scene voice of a scene involved in the current interaction, and the like. The multimedia resource of the agent includes, for example, a character image of the virtual character and background elements of the scene involved in the current interaction, etc. The form of the multimedia resource includes, but is not limited to, a static picture, a dynamic image, a short video, a slide, web page contents, virtual reality/augmented reality contents, social media contents, an animation movie, interactive elements, etc., and a specified position of the interaction interface may be set to one of the above forms or a combination thereof according to actual needs.

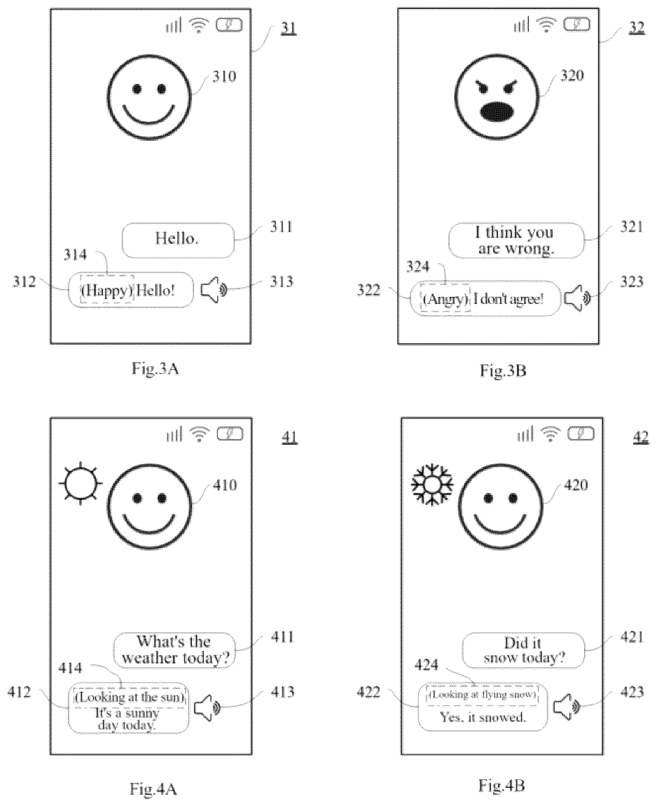

The optimized interaction method provided by the present disclosure includes an interaction interface with rich forms of expression, which may be referred to the specific embodiments shown in FIGS. 3A to 6B. Specifically, the interaction method of the present disclosure includes using a machine learning model to acquire an emotional feature of a reply text according to the reply text of the agent and a historical chat record. First, reference is made to FIGS. 3A and 3B, which are schematic diagrams of an interaction interface between a user and an agent according to some embodiments of the present disclosure. Similar to the interaction interface 1 of FIG. 1, the interaction interface 31 of FIG. 3A includes a user input 311 and a reply text 312 of the agent to the user input. In addition, the interaction interface 31 further includes a multimedia resource 310 as a picture or background picture for the interaction text of the current chat. It is to be understood that the multimedia resource 310 may be displayed in various forms, and FIG. 3A merely shows a face image with an expression as a simple example.

In a non-limiting embodiment, generating the reply text of the agent includes using the machine learning model to generate the reply text according to a historical chat record between the user and the agent; and displaying the reply text in the interaction interface. As shown in FIG. 3A, in response to the user's input 311 “Hello” in the interaction interface 31, the agent generates a reply text 312 “Hello”. Further, the machine learning model is used to acquire an emotional feature 314 of the reply text 311 according to the reply text 312 and the historical chat record. Accordingly, the emotional feature may include at least one of a semantic feature based on the reply text or a scene feature based on the historical chat record, where the semantic feature is generally used to describe a virtual character of the agent in the current interface, and the scene feature is generally used to describe a scene or environment in which the virtual character is located. In other words, the emotional feature 314 in FIG. 3A belongs to a semantic feature, which is used to represent emotion or mood that the virtual character should have based on the text content when answering. It is to be understood that the emotional feature 314 “happy” shown in FIG. 3A is presented in a text box of the reply text 3102 in a parenthesized text form, which, similar to the audio 313 presented in an icon form here, is merely used to describe an output form of the reply text in the interaction interface 31, rather than to limit the visual presentation effect of the interaction interface.

In some embodiments, a character voice of the corresponding agent is outputted in the interaction interface according to the acquired emotional feature. In particular, considering that the emotional feature includes the semantic feature based on the reply text, the character voice corresponding to the semantic feature may be outputted in the interaction interface according to the semantic feature. Specifically, the emotional feature 314 mainly includes a semantic feature, that is, the virtual character expresses “happiness”, and an audio 313 of the reply text 312 corresponding to “happiness” is outputted in the interaction interface 31. The audio 313 conforms to an acoustic feature of the emotion label “happiness” in timbre, for example, it is reflected in high pitch, strong loudness, many high-frequency components, many stress changes, brisk breathing, upward intonation, and the like. Additionally, according to the acquired emotional feature 314, a multimedia resource 310 corresponding to the emotional feature “happiness” is displayed in the interaction interface 31. As a face image, the multimedia resource 310 conforms to an image feature of the emotion label “happiness”, for example, it is reflected in mouth opening, pupil dilation, eyebrow raising, blushing, facial muscle relaxation, and the like.

Alternatively, in FIG. 3B, the interaction interface 32 shows another presentation form of an emotional feature 324. In response to a user input 321 “I think you are wrong”, the agent generates a reply text 322 “I don't agree”, and acquires an emotional feature 324 “anger” of the text according to the reply text 322 and the historical chat record. Thus, in the interaction interface 32, an audio 323 of the reply text 322 corresponding to “anger” is outputted according to the acquired emotional feature, which is reflected in timbre to conform to an acoustic feature of the emotion label “anger”, such as unstable pitch, sudden increase in loudness, acceleration of speech, shortness of breath, downward intonation, etc. ; and a multimedia resource 320 corresponding to the emotional feature “anger” is displayed, which, as a face image, conforms to an image feature of the emotion label “anger”, such as frowning, pursing lips, fixing gaze, fast and strong movement of facial muscles, and the like.

In some embodiments, considering that the emotional feature includes the scene feature based on the historical chat record, the audio of the reply text further includes the scene feature, and the scene voice corresponding to the scene feature is outputted in the interaction interface according to the scene feature. For example, if the scene in the reply text involves “New Year”, a scene feature of the New Year is acquired based on the historical chat record, and scene voice corresponding to the New Year is additionally outputted based on the scene feature of the New Year, including but not limited to acoustic elements for creating a scene atmosphere, such as firecrackers and festive music, as a supplement and foil to the aforesaid character voice.

Reference is made to FIGS. 4A and 4B, which are schematic diagrams of an interaction interface between a user and an agent according to some other embodiments of the present disclosure. In the non-limiting embodiment of FIG. 4A, in response to a user input 411 “What's the weather today” in an interaction interface 41, the agent generates a reply text 412 “It's a sunny day today”; an emotional feature 414 of the reply text 412 is acquired according to the reply text 412 and the historical chat record, which is described verbally as “looking at the sun”, and the included scene feature is “sunny” based on the historical chat record. Then, according to the emotional feature 414, a multimedia resource 410 is displayed in the interaction interface 41, which includes background elements such as the sun for representing “sunny”.

Accordingly, in FIG. 4B, in response to a user input 421 “Did it snow today”, the agent generates a reply text 422 “Yes, it snowed”; an emotional feature 424 of the reply text 422 is acquired accordingly, which is described verbally as “looking at flying snow”, and the included scene feature is “snowing” based on the historical chat record. Therefore, according to the emotional feature 424, a multimedia resource 420 is presented in an interaction interface 42, which includes background elements such as snowflakes for representing “snowing”.

In some embodiments, in response to a change in the emotional feature, at least one of a character image or a background element is changed in the interaction interface. In other words, at least one of multimedia resources is changed in the interaction interface. The multimedia resources 310 and 320 shown in FIGS. 3A and 3B are character images or parts of character images. If the interaction between the user and the agent changes from FIG. 3A to FIG. 3B, the character image of the agent is changed in the interaction interface in response to the change in the emotional feature acquired by the agent, for example, from a “happy” face image to an “angry” face image. Similarly, the multimedia resources 410 and 420 shown in FIGS. 4A and 4B contain background elements. If the interaction changes from FIG. 4A to FIG. 4B, the background elements of the chat are changed in the interaction interface in response to the change in the emotional feature, for example, from a “sunny” scene to a “snowing” scene.

In particular, in some embodiments, based on the emotional feature including at least one of the semantic feature based on the reply text or the scene feature based on the historical chat record, at least one of a label or a posture of the character is changed in the interaction interface in response to a change in the semantic feature; and/or at least one of a color scheme or a scene of the background element is changed in the interaction interface in response to a change in the scene feature.

As mentioned above, if the chat between the user and the agent changes from FIG. 3A to FIG. 3B, in response to the change in the semantic feature, the multimedia resource 310 is changed to the multimedia resource 320 in the interaction interface 31, that is, the expression of the character image is changed. It is to be understood that the multimedia resources shown in FIGS. 3A and 3B are only facial expression images, and in practice, the multimedia resource may also be presented as a full body or half body image of the virtual character when displaying the character image. Thus, as the acquired emotional feature changes, the change in the character image is reflected in a posture change of the virtual character, for example, from standing upright to standing sideways or with the back to the user.

Additionally or alternatively, if the chat between the user and the agent changes from FIG. 4A to FIG. 4B, in response to the change in the scene feature, the multimedia resource 410 is changed to the multimedia resource 420 in the interaction interface 41, that is, the scene in the background elements is changed. It is to be understood that the multimedia resources shown in FIGS. 4A and 4B are represented from the sun in a sunny day to snowflakes in a snowy day, and in practice, the multimedia resource may also be presented in other changing manners, such as changing a color scheme of the elements without displaying specific elements and keeping the content of the background elements basically unchanged, for example, changing an original warm color scheme to a color scheme with white as the main tone, etc.

In some embodiments, if a sentence of the reply text is long or includes many clauses, the reply text in one interaction includes a plurality of text segments in one-to-one correspondence with a plurality of emotional features, and the output audio accordingly includes a plurality of audio segments corresponding to the emotional features of the plurality of text segments. The reply text causes the plurality of text segments to appear in the interaction interface in sequence according to word order, and the plurality of audio segments are outputted in sequence in the interaction interface, which are aligned with the word order of the text on a time axis. Additionally, the multimedia resource in the interaction interface also cooperates with the emotional change of the reply text, and the multimedia resources corresponding to different emotional features are displayed in sequence according to word order and in a changing manner according to the emotional features of the plurality of text segments.

Specifically, reference is made to FIGS. 5A to 5C, which are schematic diagrams of an interaction interface between a user and an agent according to still some embodiments of the present disclosure. Exemplarily, in one interaction between the user and the agent, in response to a user input 51 “I've been under a lot of work pressure lately, and I'm feeling a bit listless. I don't know what to do”, the agent generates a reply text 52: “(sympathy) I'm sorry to hear that you're experiencing work stress. That does sound frustrating. (understanding) Maybe you could try some relaxing activities, like going for a walk or listening to music. That might give you back some energy. (determination) But I'm sure you can overcome your difficulties. Give yourself a little time!” According to word order, the reply text 52 includes a plurality of emotional features 54, which are “sympathy” (54-1), “understanding” (54-2) and “determination” (54-3) in sequence, and the reply text 52 is divided into three corresponding text segments accordingly, which are a text segment 52-1 “I'm sorry to hear that you're experiencing work stress. That does sound frustrating”, a text segment 52-2 “Maybe you could try some relaxing activities, like going for a walk or listening to music. That might give you back some energy” and a text segment 52-3 “But I'm sure you can overcome your difficulties. Give yourself a little time”. The output audio 53 accordingly includes a plurality of audio segments corresponding to respective text segments. Meanwhile, the interaction interface 5 also displays multimedia resources 50 corresponding to the plurality of emotional features 54 in sequence according to word order.

In other words, in the interaction interface 5, when the reply text 52-1 is displayed, an audio segment 53-1 representing “sympathy” is outputted, and a multimedia resource 50-1 representing “sympathy” is displayed; when the reply text 52-2 is displayed, an audio segment 53-2 whose emotional feature 54-2 is “understanding” is outputted, and a multimedia resource 50-2 representing “understanding” is displayed; and when the reply text 52-3 is displayed, an audio segment 53-3 whose emotional feature 54-3 is “determination” is outputted, and a multimedia resource 50-3 representing “determination” is displayed. Both switching of the multimedia resources and continuation time points of the audio segments depend on time when the emotional feature in the reply text changes, and the three are consistent in time axis nodes and sequence, thereby providing the user with multiple perceptions of sound and images in real time and enabling the user to have an immersive experience of the reply text.

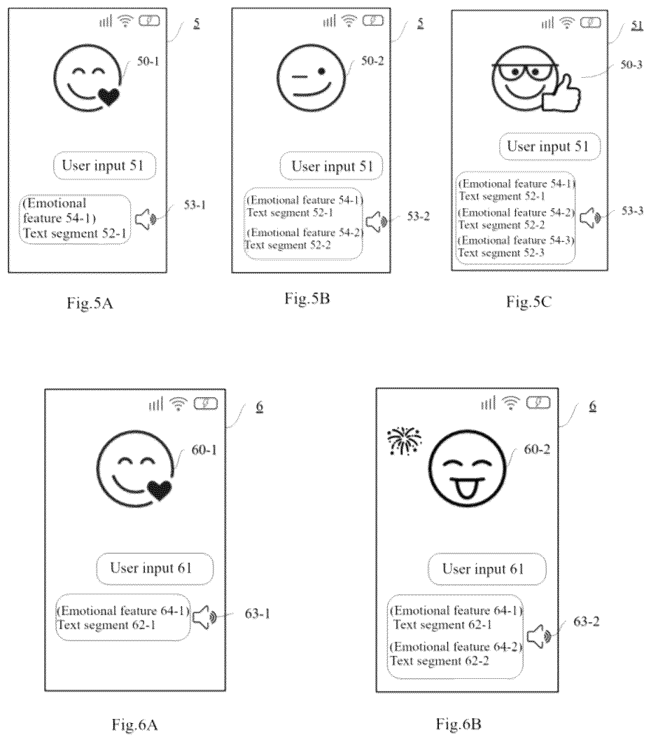

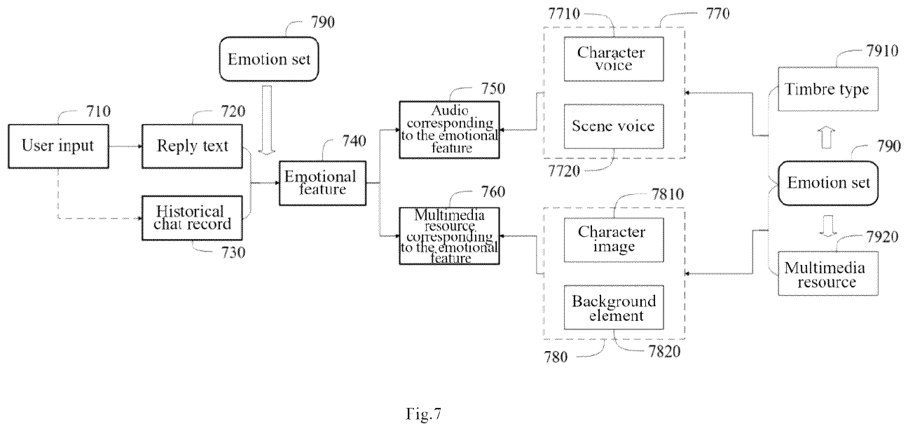

Further, FIGS. 6A and 6B are schematic diagrams of an interaction interface between a user and an agent according to still some embodiments of the present disclosure. In a non-limiting embodiment, in one interaction between the user and the agent, in response to a user input 61 “Another year is almost over. Time flies so fast. It's really disappointing”, the agent generates a reply text 62: “(understanding) The end of the year always makes people feel that time is flying by, which is really regrettable. (looking forward to the New Year) However, imagine that when the New Year's bell rings, the fireworks around are blooming, and everyone is laughing and talking. It must be very happy!” The reply text 62 includes a plurality of emotional features 64, namely, “understanding” (64-1), “looking forward to the New Year” (64-2), and two text segments 62-1 “The end of the year always makes people feel that time is flying by, which is really regrettable” and 62-2 “However, imagine that when the New Year's bell rings, the fireworks around are blooming, and everyone is laughing and talking. It must be very happy” divided accordingly. The output audio 63 accordingly includes a plurality of audio segments corresponding to respective text segments, and each audio segment includes a corresponding character voice and scene voice. Meanwhile, the interaction interface 6 also displays multimedia resources 60 corresponding to respective emotional features 64 in sequence, and each displayed multimedia resource 60 includes a corresponding character image and background element.

In particular, the emotional feature 64-1 is the semantic feature “understanding” based on the reply text, and the emotional feature 64-2 includes both the semantic feature “expectation” and the scene feature “New Year”. Therefore, when the text segment 62-1 is displayed in the interaction interface 6, the output audio segment 63-1 is a character voice representing “understanding”, and the multimedia resource 60-1 displayed at the same time is a character image representing “understanding”. Subsequently, when the text segment 62-2 is displayed in the interaction interface 6, the output audio segment 63-2 includes a character voice representing “expectation” and scene voice representing “New Year”, and the multimedia resource 60-2 displayed at the same time includes a character image representing “expectation” and background elements representing “New Year”, where, compared with the interaction interface 6 displaying the text segment 62-1, specifically, the expression of the virtual character and the scene in the chat background are changed. As such, the interaction interface may provide rich multi-form interaction experiences such as visual and auditory experiences, thereby optimizing the output effect of the agent and enhancing the appeal.

Further, reference is made to FIG. 7, which is a schematic diagram of a method for generating an audio and a multimedia resource according to some embodiments of the present disclosure. As mentioned above, the interaction between the user and the agent is mainly based on a machine learning model such as LLM to generate a reply text for the user input. In particular, an emotion set 790 is preset for the reply text, which includes various emotion labels that need to be used by the agent, such as happiness, sadness, anger, surprise, etc. In some embodiments, in the interaction interface, a reply text 720 is generated based on a user input 710, and a historical chat record 730 is composed of one or more historical data of the user input 710. According to the reply text 720 and the historical chat record 730, a machine learning model is used in combination with the preset emotion set 790, to acquire an emotional feature 740 of the reply text 720. The emotion set 790 includes pre-stored emotion labels, which are updated periodically to expand the type and number of emotion labels. The emotional feature 740 may include a semantic feature based on the reply text 720 and a scene feature based on the historical chat record 730, and these emotional features 740 may be described by one or more emotion labels in the emotion set 790. According to the acquired emotional feature, an audio 750 corresponding to the emotional feature and a multimedia resource 760 corresponding to the emotional feature are generated respectively, so as to present the audio 750 and the multimedia resource 760 to the user on the interaction interface.

Additionally, the machine learning model for acquiring the emotional feature 740 may include a non-restrictive emotion perception model, which may be trained by a text sample labeled with emotion label(s). Wherein, labeling the text sample with emotion label(s) includes clustering the text sample, and dividing a clustering result into corresponding emotion labels according to a specified granularity. Additionally, the text sample includes a semantic recognition result, that is, performing semantic recognition on the reply text in the sample, and parsing context, expression intention, emotion, etc. of the reply text therefrom. In the interaction method of the present disclosure, the semantic recognition result is mainly used to indicate a correspondence between the text content and the emotion label(s). Alternatively, keywords are set as text features, so as to label the text sample with emotion label(s) according to the text features.

Additionally, in a non-restrictive embodiment, a generation manner of the audio 750 may include: directly generating a corresponding TTS audio based on the reply text 720, where the TTS audio is a conventional audio without emotional feature(s); and retrieving a timbre feature corresponding to the emotional feature 740 from a timbre database 770, and combining the timbre feature with the TTS audio to generate the audio 750 corresponding to the emotional feature. The timbre database 770 is configured to store timbre types 7910 corresponding to respective emotion labels in the emotion set 790, such as one or more basic sounds classified according to the emotion set 790, one or more character voices 7710 set according to preset virtual character features, and one or more scene voices 7720 set according to preset scene features. In addition, a timbre generation model may also be used to generate an integrated timbre according to a combination of one or more of the character voice 7710 and the scene voice 7720, where the timbre generation model may extract features (including pitch, loudness, duration, spectrum, dynamic changes, etc.) based on analysis of existing timbres, so as to fuse features of different timbres. The fusion process may employ various techniques or methods such as generative adversarial networks, variational autoencoders, autoregressive models, etc.

Additionally, outputting the audio 750 corresponding to the emotional feature 740 in the interaction interface may further include: querying whether there is a pre-stored TTS audio corresponding to the reply text 720; and in response to the presence of such a pre-stored TTS audio, generating the audio of the reply text based on the emotional feature 740 of the reply text 720 and the TTS audio. For the agent, for some common Q&A content, corresponding TTS audio may be prepared in advance with reference to existing emotion labels in the emotion set 790. These TTS audio may have timbres corresponding to specific emotional features, or may only be simple voice conversion of common expressions. They are mainly used for generating the audio 750 corresponding to the emotional feature 740, which may save audio generation time and improve interaction efficiency of the agent.

Similarly, a multimedia feature corresponding to the emotional feature 740 is retrieved from a multimedia database 780 based on the reply text 720 and the multimedia resource 760, and the multimedia feature is applied to generate the multimedia resource 760 displayed in the interaction interface. The multimedia database 780 is configured to store multimedia types 7920 corresponding to respective emotion labels in the emotion set 790, such as one or more basic multimedia features classified according to the emotion set 790, one or more character images 7810 set according to a preset virtual character, and one or more background elements 7820 set according to preset scene features. In addition, a multimedia feature generation model may also be used to generate an integrated multimedia feature according to a combination of one or more of the basic multimedia feature, the character image, and the background element. The multimedia feature generation model may perform feature extraction on existing multimedia samples based on deep learning techniques, and use methods such as image synthesis and style transfer and the like to generate new and integrated multimedia features.

Additionally, displaying the multimedia resource of the agent corresponding to the emotional feature 740 in the interaction interface may further include: querying whether there is a pre-stored multimedia resource of the agent corresponding to the emotional feature 740 of the reply text 720; and in response to the presence of the pre-stored multimedia resource, displaying the pre-stored multimedia resource in the interaction interface as the displayed multimedia resource 760. Similar to the output audio 750 mentioned above, a change form for an existing emotion label in the emotion set 790 may be prepared for a character image of the agent in the current interaction interface and/or a background element of the interaction interface, so that it may be retrieved at any time when an emotional feature(s) is involved in the interaction, thereby improving interaction efficiency.

Further refer to FIG. 8, which is a schematic block diagram of an interaction apparatus between a user and an agent according to some embodiments of the present disclosure. Specifically, the interaction method may be implemented by the interaction apparatus 8. The interaction apparatus 8 may include a processor and a memory (not shown), where the processor may refer to various implementations of digital circuitry, analog circuitry, or mixed-signal (a combination of analog and digital) circuitry that perform functions in a computing system. The processing circuitry may include, for example, circuitry such as an integrated circuit (IC), an application specific integrated circuit (ASIC), portions or circuitry of a single processor core, an entire processor core, a single processor, a programmable hardware device such as a field programmable gate array (FPGA), and/or a system that includes a plurality of processors. Additionally, the memory of the interaction apparatus 8 may store information generated by the processor and programs and data for processor operations. The memory may be a volatile memory and/or a non-volatile memory. For example, the memory may include, but is not limited to, a random access memory (RAM), a dynamic random access memory (DRAM), a static random access memory (SRAM), a read-only memory (ROM), and a flash memory. Generally speaking, the processor may be configured to execute instructions stored on the memory to implement the interaction method between the user and the agent in the present disclosure.

Specifically, as shown in FIG. 8, in some embodiments, the interaction apparatus 8 of the present disclosure may include an input module 81, a reply module 82, an audio module 83, and a multimedia module 84. Specifically, the input module 81 is configured to receive an input from the user in an interaction interface with the agent; the reply module 82 is configured to generate a reply text of the agent based on the input; the audio module 83 is configured to output, in the interaction interface, an audio of the reply text corresponding to an emotional feature of the reply text according to the emotional feature; and the multimedia module 84 is configured to display, in the interaction interface, a multimedia resource of the agent corresponding to the emotional feature according to the emotional feature.

The present disclosure also provides an interaction device, which may include a processor, and a processor coupled to the memory, the processor configured to, based on instructions stored in the memory, carry out the interaction method for the user and the agent in the interaction interface according to any one of the embodiments described above. For the interaction device, reference may be made to FIG. 9, which is a block diagram of an electronic device according to some embodiments of the present disclosure.

The memory 91 is used to store one or more computer-readable instructions. The memory 91 may include any combination of various forms of computer-readable storage media, such as a volatile memory and/or a non-volatile memory, including but not limited to a random access memory (RAM), a dynamic random access memory (DRAM), a static random access memory (SRAM), a read-only memory (ROM), and a flash memory. The memory 91 may store, for example, an operating system, applications, a boot loader, a database, and other programs, and may also store various applications, various data, and the like.

The processor 92 is configured to run the computer-readable instructions to implement the interaction method according to any one of the embodiments described above or the method according to any one of the embodiments described above. For specific implementation of each step of the method, reference may be made to the above embodiments, and details will not be repeated herein.

The processor 92 may be configured to perform the steps of the interaction method involved in FIGS. 1 to 8. The processor 92 may be embodied as various processing apparatuses, such as a central processing unit (CPU), a network processor (NP), etc., and may also be a digital signal processor (DSP), an application specific integrated circuit (ASIC), a field programmable gate array (FPGA) or other programmable logic devices, a discrete gate or transistor logic device, or a discrete hardware component. The central processing unit (CPU) may have an X86 or ARM architecture or the like.

The processor 92 and the memory 91 may communicate with each other directly or indirectly. For example, the processor 92 and the memory 91 may communicate through a network. The network may include a wireless network, a wired network, and/or any combination of a wireless network and a wired network. The processor 92 and the memory 91 may also communicate with each other through a system bus, which is not limited in the present disclosure.

It should be noted that the components of the electronic device 9 shown in FIG. 9 are only exemplary and non-restrictive, and the electronic device 9 may have other components according to actual application needs. The processor 92 may control other components in the electronic device 9 to perform desired functions.

The electronic device 9 may be implemented by means of software, firmware, and/or hardware, and may be integrated in an apparatus installed with related applications.

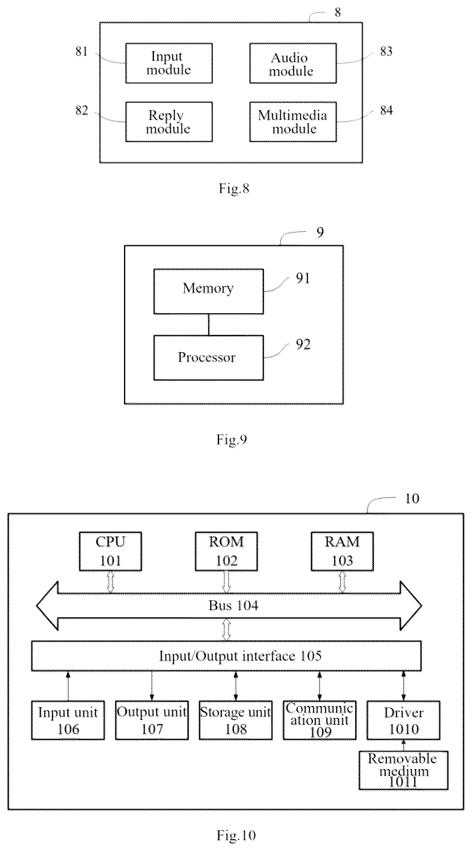

FIG. 10 is a block diagram of an electronic device according to some other embodiments of the present disclosure.

The electronic device 10 shown in FIG. 10 may be a computer system having a dedicated hardware structure, and may perform corresponding functions when installed with related applications.

The electronic device includes, but is not limited to, mobile terminals such as a smart phone, a notebook computer, a personal digital assistant (PDA), a tablet personal computer (Tablet PC), a portable multimedia player (PMP), a vehicle-mounted terminal (e.g., a vehicle navigation terminal), and a wearable device, and fixed terminals such as a digital television and a desktop computer.

As shown in FIG. 10, a central processing unit (CPU) 101 executes various processes according to a program stored in a read-only memory (ROM) 102 or a program loaded from a storage unit 108 into a random access memory (RAM) 103. The RAM 103 stores data required when the CPU 101 executes various processes, etc., as needed. The central processing unit is merely exemplary, and it may be other types of processors, such as the various processors mentioned above. The ROM 102, the RAM 103, and the storage unit 108 may be various forms of computer-readable storage media. It should be noted that although the ROM 102, the RAM 103, and the storage unit 108 are shown separately in FIG. 10, one or more of them may be combined or located in the same or different memories or memory modules.

The CPU 101, the ROM 102, and the RAM 103 are connected to each other via a bus 104. An input/output interface 105 is also connected to the bus 104.

The following components are connected to the input/output interface 105: an input unit 106, such as a touch screen, a touchpad, a keyboard, a mouse, an image sensor, a microphone, an accelerometer, a gyroscope, etc. ; an output unit 107, including a display such as a cathode ray tube (CRT), a liquid crystal display (LCD), a speaker, a vibrator, etc.; the storage unit 108, including a hard disk, a magnetic tape, etc. ; and a communication unit 109, including a network interface card such as a LAN card, a modem, etc. The communication unit 109 allows communication processing to be performed via a network such as Internet. It is easy to understand that although the components in the electronic device 10 are shown to communicate through the bus 104 in FIG. 10, they may also communicate through a network or other means, where the network may include a wireless network, a wired network, and/or any combination of a wireless network and a wired network.

A driver 1010 is also connected to the input/output interface 105 as needed. A removable medium 1011 such as a magnetic disk, an optical disc, a magneto-optical disc, a semiconductor memory, etc. is mounted on the driver 1010 as needed, so that a computer program read therefrom is installed into the storage unit 108 as needed.

In the case where the above-described series of processes are implemented by software, a program constituting the software may be installed from a network such as Internet or a storage medium such as the removable medium 1011.

The present disclosure also provides a computer-readable storage medium having computer-executable instructions stored thereon, which, when executed by a processor, causes the processor to implement the interaction method between a user and an agent according to any one of the embodiments described above.

The present disclosure also provides a computer program product, including computer-executable instructions which, when executed by a processor, causes the processor to implement the interaction method between a user and an agent according to any one of the embodiments described above.

According to an embodiment of the present disclosure, the process described above with reference to the flowchart may be implemented as a computer software program. For example, some embodiments of the present disclosure include a computer program product, which, when running on a computer, causes the computer to implement the method according to any one of the embodiments described above. The computer program product includes computer instructions carried on a computer-readable medium, including program code for carrying out the method shown in the flowchart. In such an embodiment, the computer instructions may be downloaded and installed from a network through the communication unit 109, or installed from the storage unit 108, or installed from the ROM 102. When the computer program is executed by the CPU 101, the method of the embodiment of the present disclosure is executed.

It should be noted that in the context of the present disclosure, a computer-readable medium may be a tangible medium that may contain or store a program for use by or in combination with an instruction execution system, apparatus, or device.

The computer-readable medium may be a computer-readable storage medium, a computer-readable signal medium, or any combination thereof.

The computer-readable storage medium includes, but is not limited to, an electrical, magnetic, optical, electromagnetic, infrared, or semiconductor system, apparatus, or device, or any suitable combination of the above. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium may be any tangible medium that contains or stores a program, which may be used by or in combination with an instruction execution system, apparatus, or device. The computer-readable storage medium has computer instructions stored thereon, which, when executed by the processor, implement the method according to any one of the embodiments described above.

The computer-readable signal medium may include a data signal propagated on a baseband or as a part of a carrier, and computer-readable program code is carried therein. This propagated data signal may take many forms, including but not limited to, an electromagnetic signal, an optical signal, or any suitable combination of the above. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted by any suitable medium, including but not limited to, a wire, an optical cable, a radio frequency (RF), etc., or any suitable combination of the above.

The above computer-readable medium may be included in the above electronic device, or it may exist alone without being assembled into the electronic device.

In some embodiments, a computer program is also provided, including: instructions that, when executed by a processor, cause the processor to perform the method according to any one of the embodiments described above. For example, the instructions may be embodied as computer program code.

In the embodiments of the present disclosure, the computer program code for performing the operations of the present disclosure may be written in one or more programming languages or a combination thereof, where the programming languages include, but are not limited to, an object-oriented programming language such as Java, Smalltalk, and C++, and further include conventional procedural programming languages such as “C” language or similar programming languages. The program code may be executed entirely on a user's computer, partly executed on a user's computer, executed as an independent software package, partly executed on a user's computer and partly executed on a remote computer, or entirely executed on a remote computer or server. In the case of involving a remote computer, the remote computer may be connected to a user's computer through any kind of network, including a local area network (LAN) or a wide area network (WAN), or it may be connected to an external computer (for example, connected by using Internet provided by an Internet service provider).

The flowcharts and block diagrams in the drawings illustrate the possibly implemented architectures, functions, and operations of the system, method, and computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The functions described above may be performed at least partially by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), etc.

Although some specific embodiments of the present disclosure have been described in detail by way of examples, those skilled in the art should understand that the above examples are only for illustration and not for limiting the scope of the present disclosure. Those skilled in the art should understand that the above embodiments may be modified without departing from the scope and spirit of the present disclosure. The scope of the present disclosure is defined by the appended claims.

1. An interaction method, comprising:
receiving an input from a user in an interaction interface with an agent;
generating a reply text of the agent based on the input;
outputting, in the interaction interface, an audio of the reply text corresponding to an emotional feature of the reply text according to the emotional feature; and
displaying, in the interaction interface, a multimedia resource of the agent corresponding to the emotional feature according to the emotional feature of the reply text.

2. The interaction method of claim 1, further comprising:
using a machine learning model to acquire the emotional feature of the reply text according to the reply text and a historical chat record between the user and the agent;
wherein the emotional feature comprises at least one of a semantic feature based on the reply text or a scene feature based on the historical chat record.

3. The interaction method of claim 1, wherein the audio of the reply text comprises a character voice of the agent,
outputting, in the interaction interface, the audio of the reply text corresponding to the emotional feature of the reply text according to the emotional feature comprises:
outputting the character voice in the interaction interface according to the emotional feature.

4. The interaction method of claim 3, wherein the emotional feature comprises a semantic feature based on the reply text,
outputting, in the interaction interface, the audio of the reply text corresponding to the emotional feature of the reply text according to the emotional feature comprises:
outputting, in the interaction interface, the character voice corresponding to the semantic feature according to the semantic feature.

5. The interaction method of claim 4, wherein the emotional feature further comprises a scene feature based on a historical chat record between the user and the agent, and the audio of the reply text further comprises scene voice,
outputting, in the interaction interface, the audio of the reply text corresponding to the emotional feature of the reply text according to the emotional feature further comprises:
outputting, in the interaction interface, the scene voice corresponding to the scene feature according to the scene feature.

6. The interaction method of claim 1, wherein the reply text comprises a plurality of text segments in one-to-one correspondence with a plurality of emotional features, and the audio comprises a plurality of audio segments corresponding to the emotional features of the plurality of text segments,
outputting, in the interaction interface, the audio of the reply text corresponding to the emotional feature of the reply text according to the emotional feature comprises:
outputting the plurality of audio segments in sequence in the interaction interface.

7. The interaction method of claim 6, wherein displaying, in the interaction interface, the multimedia resource of the agent corresponding to the emotional feature according to the emotional feature of the reply text comprises:
displaying, in the interaction interface, corresponding multimedia resource in a changing manner in sequence according to the emotional features of the plurality of text segments.

8. The interaction method of claim 1, wherein the multimedia resource comprises at least one of a character image or a background element of the agent,
displaying, in the interaction interface, the multimedia resource of the agent corresponding to the emotional feature according to the emotional feature of the reply text comprises:
changing at least one of the character image or the background element in the interaction interface in response to a change in the emotional feature.

9. The interaction method of claim 8, wherein the emotional feature comprises at least one of a semantic feature based on the reply text or a scene feature based on a historical chat record between the user and the agent,
displaying, in the interaction interface, the multimedia resource of the agent corresponding to the emotional feature according to the emotional feature of the reply text comprises:
changing at least one of an expression or a posture of the character image in the interaction interface in response to a change in the semantic feature; and/or changing at least one of a color scheme or a scene of the background element in the interaction interface in response to a change in the scene feature.

10. The interaction method of claim 1, wherein outputting, in the interaction interface, the audio of the reply text corresponding to the emotional feature comprises:
querying whether a text-to-speech (TTS) audio corresponding to the reply text is pre-stored;
in response to the TTS audio being pre-stored, generating the audio of the reply text based on the emotional feature of the reply text and the TTS audio.

11. The interaction method of claim 1, wherein displaying, in the interaction interface, the multimedia resource of the agent corresponding to the emotional feature comprises:
querying whether there is a pre-stored multimedia resource of the agent corresponding to the emotional feature of the reply text;
in response to the presence of the pre-stored multimedia resource, displaying the pre-stored multimedia resource in the interaction interface as the multimedia resource.

12. The interaction method of claim 1, wherein generating the reply text of the agent based on the input comprises:
using a machine learning model to generate the reply text according to a historical chat record between the user and the agent; and
displaying the reply text in the interaction interface.

13. An electronic device, comprising:
a memory; and
a processor coupled to the memory, the processor configured to, based on instructions stored in the memory, perform the following steps:
receiving an input from a user in an interaction interface with an agent;
generating a reply text of the agent based on the input;
outputting, in the interaction interface, an audio of the reply text corresponding to an emotional feature of the reply text according to the emotional feature; and
displaying, in the interaction interface, a multimedia resource of the agent corresponding to the emotional feature according to the emotional feature of the reply text.

14. The electronic device of claim 13, wherein the processor is configured to further carry out the following step:
using a machine learning model to acquire the emotional feature of the reply text according to the reply text and a historical chat record between the user and the agent;
wherein the emotional feature comprises at least one of a semantic feature based on the reply text or a scene feature based on the historical chat record.

15. The electronic device of claim 13, wherein the audio of the reply text comprises a character voice of the agent,
outputting, in the interaction interface, the audio of the reply text corresponding to the emotional feature of the reply text according to the emotional feature comprises:
outputting the character voice in the interaction interface according to the emotional feature.

16. The electronic device of claim 13, wherein outputting, in the interaction interface, the audio of the reply text corresponding to the emotional feature comprises:
querying whether a text-to-speech (TTS) audio corresponding to the reply text is pre-stored;
in response to the TTS audio being pre-stored, generating the audio of the reply text based on the emotional feature of the reply text and the TTS audio.

17. The electronic device of claim 13, wherein displaying, in the interaction interface, the multimedia resource of the agent corresponding to the emotional feature comprises:
querying whether there is a pre-stored multimedia resource of the agent corresponding to the emotional feature of the reply text;
in response to the presence of the pre-stored multimedia resource, displaying the pre-stored multimedia resource in the interaction interface as the multimedia resource.

18. A computer-readable storage medium having a computer program stored thereon, which, when executed by a processor, performs the following steps:
receiving an input from a user in an interaction interface with an agent;
generating a reply text of the agent based on the input;
outputting, in the interaction interface, an audio of the reply text corresponding to an emotional feature of the reply text according to the emotional feature; and
displaying, in the interaction interface, a multimedia resource of the agent corresponding to the emotional feature according to the emotional feature of the reply text.

19. The computer-readable storage medium of claim 18, wherein the processor is configured to further carry out the following step:
using a machine learning model to acquire the emotional feature of the reply text according to the reply text and a historical chat record between the user and the agent;
wherein the emotional feature comprises at least one of a semantic feature based on the reply text or a scene feature based on the historical chat record.

20. The computer-readable storage medium of claim 18, wherein the audio of the reply text comprises a character voice of the agent,
outputting, in the interaction interface, the audio of the reply text corresponding to the emotional feature of the reply text according to the emotional feature comprises:
outputting the character voice in the interaction interface according to the emotional feature.
